(19) United States
(12) Patent Application Publication
(10) Pub. No.: US 2010/0015527 A1
(43) Pub. Date: Jan. 21, 2010

(54) Electromotive device

(76) Inventors: Fuminori Yamaguchi, Tokyo (JP); Nahoko Umehara, Tokyo (JP)

Correspondence Address: JACOBSON HOLMAN PLLC, 400 SEVENTH STREET N.W., SUITE 600, WASHINGTON, DC, 20004, US

(21) Appl. No.: 11/988,878

(22) PCT Filed: Jul. 13, 2006
(86) PCT No.: PCT/JP2006/313965

§ 371 Date: Sep. 8, 2009

(30) Foreign Application Priority Data
Jul. 20, 2005 (JP) 2005-209621
Jul. 20, 2005 (JP) 2005-209622
Jul. 20, 2005 (JP) 2005-209623

(51) Int. Cl. H01M 4/50

(52) U.S. Cl. 429/224

(57) ABSTRACT

Adequacy of a charge/discharge cycle of a secondary battery as an electromotive apparatus is realized.

A phosphate mineral powder containing at least one, two, or more elements selected from cerium, lanthanum, praseodymium, neodymium, and thorium is carried in at least one of a positive electrode active material, a negative electrode active material, and a separator, or contained in an active material layer formed on one electrode so as to face the other electrode. With such a structure, discharge duration characteristics for a long time in the electromotive apparatus can be obtained.

### TECHNICAL FIELD

The present invention relates to a technology that realizes adequacy of a charge/discharge cycle of a secondary battery as an electromotive apparatus.

### BACKGROUND ART

As a separator of a secondary battery used as an electromotive apparatus, one formed of a material, e.g., paper, a glass mat, a film formed of a synthetic resin having micropores, a nonwoven fabric, or ceramics having micropores is often used. The separator satisfies electrochemically required conditions, e.g., an accuracy of an interval between a positive electrode material and a negative electrode material, a diffusivity of an electrolyte, a gas permeability, an ion conductivity, and others.

Meanwhile, in the secondary battery, quick charging is becoming an essential condition, and especially quick charging of a lead-based secondary battery is a technology that should be established as soon as possible in terms of convenience of existing various apparatuses. Further, this is also true in regard to a lithium-based secondary battery (which will be referred to as an LiB hereinafter) having a high energy density.

However, occurrence of a lead-oxide-film-like precipitate (sulfation) of PbB and a lithium dendritic precipitate (dendrite) of LiB caused due to amplification of a resistance in a battery involved by quick charging obstructs quick charging of such batteries.

Thus, in order to suppress occurrence of the sulfation and the dendrite irrespective of a material of the separator, a technology of carrying an activated carbon in the separator is well known (see, e.g., Patent Document 1).

Patent Document 1: Japanese Patent Application Laid-open No. 2002-134086

### DISCLOSURE OF INVENTION

### Problem to be Solved by the Invention

The present invention intends to realize further adequacy of a charge/discharge cycle of a secondary battery while considering the conventional situations.

### Means for Solving Problem

Thus, an electromotive apparatus according to claim 1 of the present invention is characterized in that a phosphate mineral powder containing at least one, two, or more elements selected from cerium, lanthanum, praseodymium, neodymium, and thorium is carried in at least one of a positive electrode active material, a negative electrode active material, and a separator, or contained in an active material layer formed on one electrode so as to face the other electrode.

In the electromotive apparatus according to claim 1, the apparatus according to claim 2 is characterized in that the phosphate mineral powder is monazite.

In the electromotive apparatus according to claim 1 or claim 2, the apparatus according to claim 3 is characterized in that the positive electrode active material is a lead oxide and the negative electrode active material is lead.

In the electromotive apparatus according to claim 1 or claim 2, the apparatus according to claim 4 is characterized in that the positive electrode active material is a nickel oxyhydroxide or a nickel hydride and the negative electrode active material is a hydrogen storage metal.

In the electromotive apparatus according to claim 1 or claim 2, the apparatus according to claim 5 is characterized in that the positive electrode active material is a nickel oxyhydroxide or a nickel hydride and the negative electrode active material is a metal containing cadmium.

In the electromotive apparatus according to claim 1 or claim 2, the apparatus according to claim 6 is characterized in that the positive electrode active material is a lithium cobaltoxide and the negative electrode active material is graphite.

In the electromotive apparatus according to claim 1, the apparatus according to claim 7 is characterized in that the active material layer contains powders of one, two, or more materials selected from a manganese dioxide, activated carbon, graphite, and tourmaline.

In the electromotive apparatus according to claim 7, the apparatus according to claim 8 is characterized in that the active material layer has a binder kneaded therein and is applied to the one electrode.

In the electromotive apparatus according to claim 1, the apparatus according to claim 9 is characterized in that the active material layer is obtained by calcining a phosphate mineral powder containing at least one, two, or more elements selected from cerium, lanthanum, praseodymium, neodymium, and thorium and powders of one, two, or more materials selected from a manganese dioxide, activated carbon, graphite, and tourmaline on the one electrode.

In the electromotive apparatus according to any one of claims 1 to 9, the apparatus according to claim 10 is characterized in that at least one electrode is formed of aluminum.

In the electromotive apparatus according to any one of claims 1 to 10, the apparatus according to claim 11 is characterized in that the electromotive apparatus is a secondary battery.

### EFFECT OF THE INVENTION

The present invention can realize adequacy of the charge/discharge cycle of the secondary battery by using a material in which a phosphate mineral powder containing one, two, or more elements selected from cerium, lanthanum, praseodymium, neodymium, and thorium or a substance having a strong oxidation-reduction effect like a powder of monazite as the phosphate mineral powder is carried in at least one of a positive electrode active material, a negative electrode active material, and a separator, or by containing the phosphate mineral material or the substance having the strong oxidation-reduction effect in the active material layer formed on the one electrode to face the other electrode.

### BEST MODES FOR CARRYING OUT THE INVENTION

The best modes for carrying out the present invention will now be explained hereinafter with reference to illustrated embodiments.

### First Embodiment

Although a first embodiment uses at least one of a positive electrode active material, a negative electrode active material, and a separator in which a phosphate mineral powder containing one, two, or more elements selected from cerium, lanthanum, praseodymium, neodymium, and thorium or a powder of monazite as the phosphate mineral powder is carried, the phrase “being carried” in this specification means a state that the powder or a product of the power is pressed against or kneaded into the positive electrode active material or the negative electrode active material, a state where the same is interposed between fibers of a material, e.g., paper constituting the separator, a state where the same is added to be integrated with a material forming the separator, or a state as a combination of these states.

It is to be noted that, as the separator of a secondary battery, one formed of a material, e.g., paper, a glass mat, a film formed of a synthetic resin having micropores, a nonwoven fabric, or ceramics having micropores is often used. The separator satisfies electrochemically required conditions, e.g., an accuracy of an interval between a positive electrode material and a negative electrode material, a diffusivity of an electrolyte, a gas permeability, an ion conductivity, and others.

According to the first embodiment, in such a lead-based secondary battery (an electromotive apparatus) (both positive and negative polar plates 1 are formed of Pb, a positive electrode 2: an active material is a molded product formed of powders of PbO and PbO₂, a negative electrode 3: an active material is a molded product of a Pb powder, and a separator 4 is interposed between such positive electrode 2 and negative electrode 3) as shown in FIG. 1, there is a description that a powder is carried when the powder or its product is put between fibers if the separator 4 is paper, a glass mat, a film of a synthetic resin having micropores, or a nonwoven fabric or when the powder or its product is put in micro pores if the separator is formed of a material, e.g., a film of a synthetic resin having the micropores, a nonwoven fabric or ceramics having micropores, or when the powder or its product is added to powder materials forming the positive electrode 2 and the negative electrode 3 and integrated as an active material in the battery depicted in FIG. 1 or when both the structures are adopted.

Further, as the secondary battery according to the first embodiment, one having a structure where a phosphate mineral powder containing one, two, or more elements selected from cerium, lanthanum, praseodymium, neodymium, and thorium is carried in the separator 4 is used. As the phosphate mineral powder, a powder of monazite can be used. Furthermore, as explained above, a lead oxide can be used as an active material of the positive electrode 2, and a powder of lead can be used as an active material of the negative electrode 3. A nickel oxyhydroxide or a nickel hydride may be used as the positive electrode active material, and a hydrogen storage metal may be used as the negative electrode active material. Moreover, a nickel oxyhydroxide or a nickel hydride may be used as the positive electrode active material and a metal containing cadmium may be used as the negative electrode active material, or a lithium cobaltoxide may be used as the positive electrode active material and graphite may be used as the negative electrode active material.

It is to be noted that, as a carrying method, adopting various known methods can suffice, thereby omitting a detailed explanation thereof. Positive and negative polar plates of the following commercially available battery were taken out one by one, and a powder of monazite was pressed and carried in a polar plate active material. Therefore, one cell is provided. It can be considered that kneading this powder enables obtaining the same effect.

### Example 1

As an example of the first embodiment, particulars of a discharge duration comparison experiment conducted by the present inventors will now be explained.

(1) First, positive and negative polar plates of the following commercially available lead storage battery (FT4L-BS manufactured by The Furukawa Battery Co., Ltd.) were removed one by one, a separator was sandwiched between these plates (therefore, one cell is provided), and this structure was immersed in a 41% sulfuric acid electrolyte to perform charge and discharge. As the separator, a genuine product of The Furukawa Battery Co., Ltd., a product containing carbon/tourmaline, a product containing activated carbon as well as an embodied product of the present invention (the powder of monazite was used) were used.

As experimental conditions, a discharge end voltage was set to 0 V, and very strict conditions were adopted, where a charge voltage was 2.5 V, a charging time was one hour, a discharge current was 0.5 A (1 C discharge: charge/discharge with a capacitance A of the cell), a discharging time was two hours, and adopted polar plates had 2 V and 0.5 Ah. It is to be noted that the discharge end voltage was set to 0 V, but it is usually 1.67 V/cell, and discharge was daringly performed until 0 V in this experiment to obtain a result in a short time and an effect was confirmed. FIG. 2 shows an experiment result. As shown in the drawing, the product according to the present invention (the secondary battery according to the first embodiment) has the longest discharge duration except the first time, and the same result was obtained even though the experiment was repeated.

As shown in FIG. 3, a change in an internal resistance before and after the experiment was measured. Although the internal resistance increases with a charge/discharge cycle, that is because the positive electrode that is turned to a lead oxide at the time of charging cannot completely restore to a lead sulfate by charging. This is the above-explained sulfation. It has been revealed that the battery according to the present invention has the lowest increasing rate of the internal resistance as compared with the genuine product of the commercially available battery, the product containing carbon/tourmaline, and the product containing activated carbon. Additionally, although changes in the polar plates are not shown, appearances of the polar plates were not changed in the product according to the present invention (the secondary battery according to the first embodiment).

### Second Embodiment

FIG. 4 is a cross-sectional view conceptually showing a structure of a battery as an example of an electromotive apparatus according to a second embodiment. In the drawing, reference numerals 11 and 12 denote polar plates formed of aluminum, reference numeral 13 designates a separator, and an active material layer 14 formed of monazite and activated carbon is interposed between the positive polar plate 11 and the separator 13.

In the second embodiment, the active material layer 14 can be provided on one electrode 11 and the other electrode 2 can be arranged to face this electrode, but the active material layer 14 may be provided on each of the electrodes 11 and 12. Further, a material constituting the active material layer 14 is a substance including a phosphate mineral powder containing one, two, or more elements selected from cerium, lanthanum, praseodymium, neodymium, and thorium and powders of one, two, or more materials selected from a manganese dioxide, activated carbon, graphite, and tourmaline.

Furthermore, the active material layer 14 can be formed by at least kneading a phosphate mineral powder containing one, two, or more elements selected from cerium, lanthanum, praseodymium, neodymium, and thorium, powders of one, two, or more materials selected from a manganese dioxide, activated carbon, graphite, and tourmaline, and a binder and applying the obtained material to one or both the electrodes 11 and 12. Moreover, this layer can be also formed by calcining a phosphate mineral powder containing at least one, two, or more elements selected from cerium, lanthanum, praseodymium, neodymium, and thorium, and powders of one, two, or more materials selected from a manganese dioxide, activated carbon, graphite, and tourmaline on one or both the electrodes 11 and 12.

### Example 2

As an example of the second embodiment, particulars of an electromotive demonstration experiment conducted by the present inventors will now be explained.

### Demonstration Example

An electromotive phenomenon caused due to a powder of monazite and activated carbon was confirmed under environmental conditions where a weather: fair, an air temperature: 21° C., and a relative humidity: 40%.

### <Physical Conditions>

### Polar Plate (A Positive Electrode and a Negative Electrode are Formed of the Same Material)

Material: high-purity aluminum

Board thickness: 50 microns, foil-like shape, uniform

Area: 15 mm×25 mm (375 square mm)

Fetched portion: folded with an area of 15 mm×2 mm

### Active Material

Application: applied to a gluing surface: application of one layer or two layers

Application method: a back surface of an aluminum foil was used

Adhesive: acrylic-resin-based adhesive

Main raw material: main active material containing a lanthanoid-based mineral powder and an activation carbon powder

Measurement: voltmeter, ammeter (trade name: SAMWA DIGITAL MULTIMETER PC20)

Measurement method: direct contact of a probe of the above measurement instrument: incidentally, the probe is formed by gold plating

A result depicted in FIG. 5 was obtained, and the electromotive phenomenon caused due to the monazite powder and the activated carbon was confirmed. In this electromotive phenomenon, when a lanthanoid-based material, e.g., cerium or lanthanum undergoes a disintegration, electrons stored in an activation material including a powder of phosphate mineral, e.g., monazite are excited, and this becomes an electromotive force.

### BRIEF DESCRIPTION OF DRAWINGS

FIG. 1 is a conceptual view showing a structure of a lead-based secondary battery according to a first embodiment;

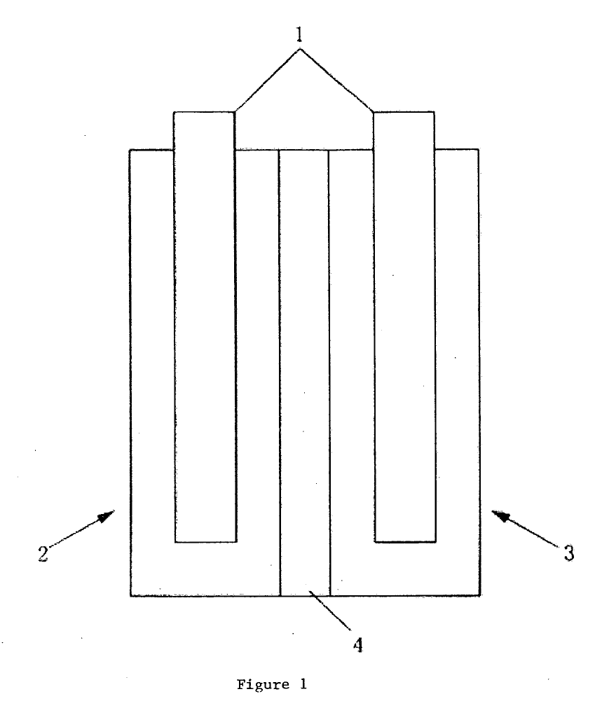

FIG. 2 is a view showing a result of a discharge duration comparison experiment of a product according to the present invention and others;

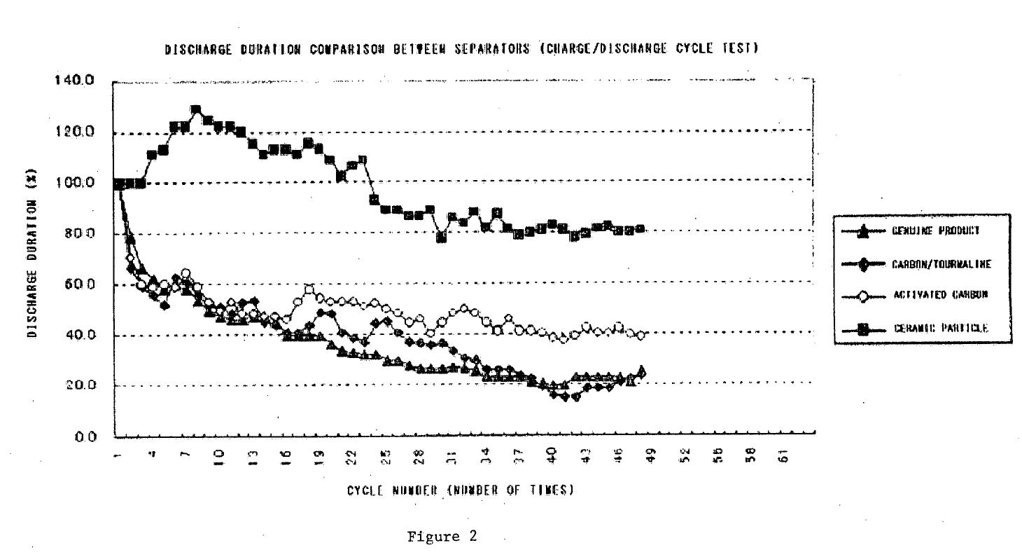

FIG. 3 is a view showing a measurement result of an increasing rate of an internal impedance before and after the discharge duration comparison experiment of the product according to the present invention and others;

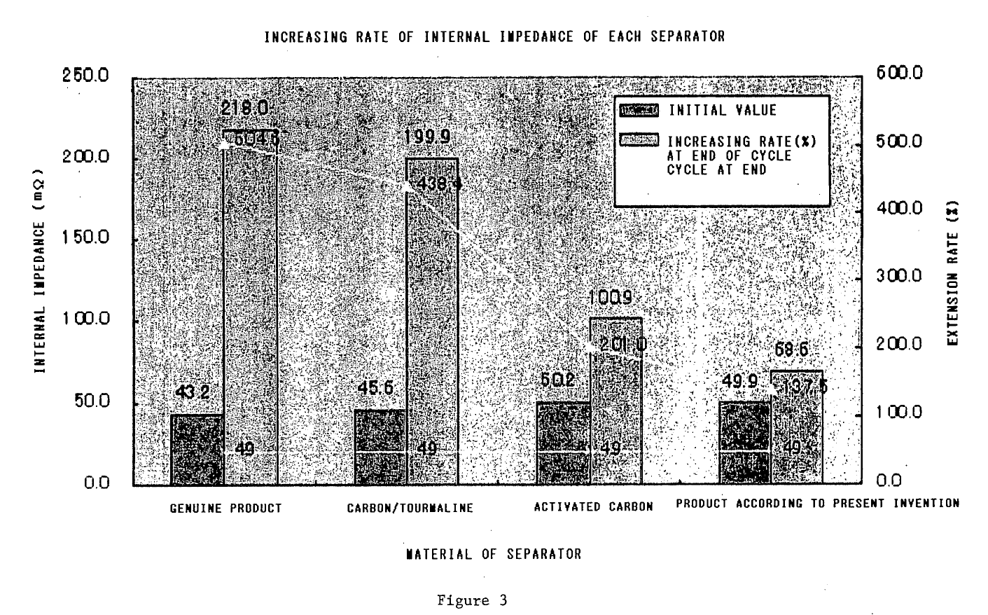

FIG. 4 is a cross-sectional view conceptually showing a structure of a battery as an example of an electromotive apparatus according to a second embodiment; and

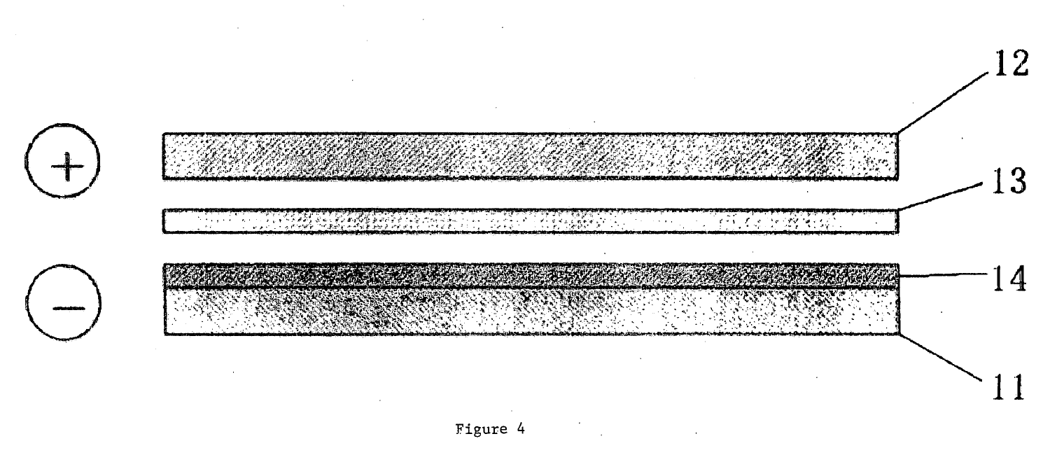

FIG. 5 is a view showing a result of an electromotive demonstration experiment conducted by the present inventors.

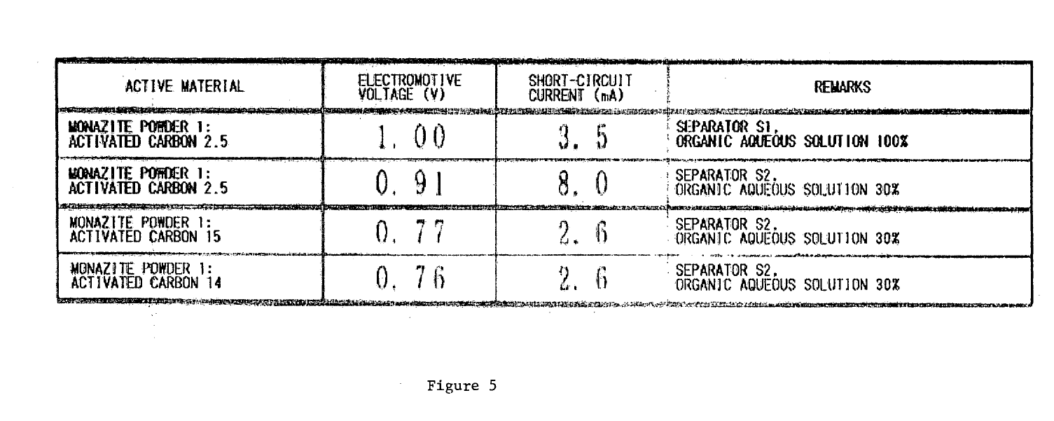

### EXPLANATIONS OF LETTERS OR NUMERALS

1: polar plate
2: positive electrode
3: negative electrode
4: separator
11: polar plate
12: polar plate
13: separator
14: active material layer

1. An electromotive apparatus, wherein an active material layer formed on one electrode so as to face the other electrode is obtained by forming a phosphate mineral powder containing at least one, two, or more elements selected from cerium, lanthanum, praseodymium, neodymium, and thorium and powders of one, two, or more materials selected from a manganese dioxide, activated carbon, graphite, and tourmaline on the one electrode.

2. The electromotive apparatus according to claim 1, wherein the active material layer is formed on the one electrode and the other electrode.

3. The electromotive apparatus according to claim 1, wherein the active material layer is calcined on the one electrode and/or the other electrode.

4. The electromotive apparatus according to claim 1, wherein the active material layer has a binder kneaded therein and is applied to the one electrode and/or the other electrode.

5. The electromotive apparatus according to claim 1, wherein at least one electrode is formed of aluminum.

6. The electromotive apparatus according to claim 1, wherein the electromotive apparatus is a secondary battery.
